(19) United States
(12) Patent Application Publication
(10) Pub. No.: US 2017/0319307 A1
(43) Pub. Date: Nov. 9, 2017

(54) TRANSPARENT AND RADIO-OPAQUE RETENTION PIN

(71) Applicant: SOCIETE DE RECHERCHES TECHNIQUES DENTAIRES - R.T.D., SAINT-EGREVE (FR)

(72) Inventors: Manh-Quynh CHU, SAINT EGRÈVE (FR); Pierre-Luc REYNAUD, VAULNAVEYS LE HAUT (FR); Marc REYNAUD, MEYLAN (FR)

(21) Appl. No.: 15/661,390

(22) Filed: Jul. 27, 2017

Related U.S. Application Data
(63) Continuation of application No. 11/924,976, filed on Oct. 26, 2007.
Application No. 11/924,976 is a continuation-in-part of application No. 10/243,873, filed on Sep. 16, 2002, now abandoned.
Application No. 10/243,873 is a continuation of application No. 09/806,234, filed on Mar. 28, 2001, now abandoned.

(30) Foreign Application Priority Data
Jul. 30, 1999 (FR) 99/09900

(51) Int. Cl. A61C 13/30

(52) U.S. Cl. CPC A61C 13/30; A61C 2201/005

(57) ABSTRACT

A dental retention pin made of composite material includes a core consisting of fibers embedded in a resin matrix. The fibers, which have a refractive index (n), are radio-opaque, and the refractive index (n′) of the resin forming the matrix has a value close to that of the fibers.

### BACKGROUND OF THE INVENTION

The present invention relates to a dental retention pin made of composite material of the type adapted to be fixed in the root of a tooth by means of a photopolymerisable adhesive, as well as to a process for manufacturing same.

It is known that, in the dental art, retention pins are used for reconstituting pulp-amputated teeth, which are fixed in the radicular canal of the tooth and which serve as support for an external reconstitution thereof Such retention pins are generally constituted by various metals, and in particular stainless steel, these metals presenting the drawback of often giving rise to phenomena of corrosion. Furthermore, such retention pins, due in particular to the great difference existing between their modulus of transverse elasticity and that of the dentin in which they are implanted, tend in time to be disconnected from the latter.

In order to overcome these various drawbacks, it has been proposed to make dental retention pins from a composite material, i.e. a material essentially constituted by synthetic fibers embedded in a synthetic resin and in particular an epoxy resin. In order to give this composite material the qualities of mechanical strength which are necessary for it to withstand the efforts of mastication exerted on the retention pin, in particular in the longitudinal direction, high-resistance fibers such as carbon fibers are employed, of which the axis is arranged parallel to that of the retention pin and which extend in equi-tensioned manner over the whole length thereof. Furthermore, these retention pins are arranged to present a modulus of elasticity in the transverse direction which is close to that of the dentin in order to respect the latter when transverse efforts are exerted on these retention pins, particularly during mastication.

Retention pins of this type, although they are quite satisfactory concerning resistance to the different mechanical stresses, present the drawback of being transparent to X-rays, this preventing them from being easily located by the practitioner.

Various means for ensuring the opacity of these retention pins to X-rays have been proposed in the prior state of the art.

Furthermore, it is known that the fixation of the dental retention pins in the radicular canal of a tooth may be effected by means of photopolymerisable adhesives, i.e. of synthetic monomers of which the reaction of polymerisation is provoked by a light radiation whose wavelength lies in the visible range. Such adhesives are particularly interesting in dentistry, insofar as they allow the practitioner to activate the reaction of polymerisation strictly at the instant when he/she wishes. However, such photopolymerisable adhesives are, most of the time, difficult to employ insofar as it is particularly difficult to effect illumination of the bottom of the radicular canal sufficiently efficiently.

This is why it has been proposed to employ bars constituted by a transparent material, which are adapted to convey the light radiation necessary for triggering of polymerisation of the adhesive.

However, it has been observed that such retention pins, although they ensured a good polymerisation, presented generally too weak mechanical characteristics, rendering them unsuitable for the desired use.

### SUMMARY OF THE INVENTION

The present invention proposes a dental retention pin made of composite material which simultaneously presents the three ideal characteristics of a dental retention pin, namely mechanical characteristics enabling it to perform its own function, a transparency in visible light allowing the passage of the light radiations necessary for carrying out the reaction of polymerisation of the adhesive, and an opacity concerning the propagation of X-rays.

The present invention thus relates to a dental retention pin made of composite material of the type comprising a core consisting of fibers embedded in a resin matrix, characterized in that the fibers which have a refractive index are radio-opaque and the refractive index of the resin forming the matrix has a value close to that of the fibers.

The proportion of fibers in the retention pin will preferably be less than 70% by volume.

### DESCRIPTION OF PREFERRED EMBODIMENTS

In an embodiment of the invention, the refractive index of the resin used will be adjusted with respect to the refractive index of the fibers. In this way, in the event of the refractive index of the resin being too low with respect to that of the fibers, this index will be increased by adding fillers such as for example amorphous silica or other compounds such as certain oxides and in particular metal oxides. In the event of the refractive index of the resin being too high, it will in that case be possible to reduce it by diluting the synthetic resin in a solvent. The solvent is a mixture of the resin and at least another chemical compound that is compatible with the resin and that affects its viscosity. The solvent may be, for example, a diluent or another resin.

The refractive index of the resin may also be adjusted with respect to that of the fibers by mixing two different resins, compatible with each other, and presenting relatively far-apart refractive indices, which will make it possible to obtain, by mixing, a desired specific refractive index included between the extreme limits of these two resins. At least one of these resins will preferably have a refractive index greater than that of the fibers. Furthermore, the absolute value of the difference between the refractive index of the fibers and that of the resin matrix is preferably less than 0.15, advantageously less than 0.10, more advantageously less than 0.05, and even more advantageously less than 0.02.

The present invention also has for an object a process for producing a dental retention pin of the type comprising a core of radio-opaque fibers extending from one end of the retention pin to the other and which are embedded in a resin matrix, characterized in that it comprises the steps consisting in:

using a minimum quantity of fibers for giving the retention pin, on the one hand, the mechanical characteristics and, on the other hand, the degree of radio-opacity desired,

using a resin to constitute the matrix whose refractive index is close to the refractive index of the fibers.

Various forms of embodiment of the present invention will be described hereinafter by way of non-limiting examples.

### EXAMPLE 1

In a first form of embodiment of the invention, dental retention pins were made from synthetic fibers so-called of AR (“alkali resistant”) type which are fibers used in the domain of building, due to their good long-term chemical resistance to acid and alkaline attacks. This good resistance is given to them by the zirconium dioxide that they contain (16%). It has been observed that the zirconium dioxide also renders these fibers radio-opaque when they are illuminated by a beam of X-rays. Their refractive index is 1.562 when they are illuminated by a radiation corresponding to the sodium line. With the aid of these fibers, a composite rod was constituted, using a resin constituted by 55% by weight of a modified epoxy resin and by 45% by weight of a solvent/diluent whose refractive index is 1.546 (Visible range at 20.degree. C.). In this rod, the fibers were disposed so as to be oriented in the longitudinal direction and continuously over the whole length of the rod. Such a rod comprised 64% by volume of fibers and 36% by volume of resin. This rod was then cut up so as to form dental retention pins about 20 min long.

These retention pins were then tested, both concerning their opacity to X-rays and concerning their transparency, i.e. their capacity of transmitting, from downstream to upstream, the light energy necessary for the polymerisation of an adhesive.

A tooth fitted with such a retention pin was thus subjected to a radiation furnished by a radiology apparatus of the type usually used in a dentist's surgery (75 kV, exposure 0.06) and it was ascertained that such a retention pin distinguished itself perfectly in the tests.

There were then arranged, at the end of this retention pin, an adhesive of photopolymerisable type, and, around its upstream part, an opaque mask, so as to illuminate with an appropriate apparatus only the upstream end of this retention pin. This end was thus illuminated for a duration of 40 seconds and it was ascertained that the adhesive was totally polymerised.

As for the mechanical properties of the dental retention pins thus obtained, the following values were measured:
Breaking stress at flexion: 1570 MPa
Modulus of elasticity in longitudinal extension: 47 GPa
Modulus of elasticity in flexion: 49
GPa Interlaminary shear stress: 66 MPa

It is thus ascertained that these properties guarantee the high mechanical quality of these retention pins.

### EXAMPLE 2

Retention pins were made from basic constituents identical to the preceding ones, only the proportions of fibers and of resin being modified, and 43% by volume of fibers and 57% by volume of resin was thus used.

The tests which were effected on these retention pins demonstrated that their implementation was easier due to the better fluidity of the product. It was also ascertained that their transparency was much improved with respect to that obtained on the preceding retention pins. Furthermore, it was ascertained that these retention pins had a good resistance to solvents.

The mechanical properties have decreased slightly with respect to the preceding values, but nonetheless remain very satisfactory for the desired applications:
Breaking stress at flexion: 972 MPa
Modulus of elasticity in longitudinal extension: 33 GPa
Modulus of elasticity in flexion: 40
GPa Interlaminary shear stress: 54 MPa

### EXAMPLE 3

One of the difficulties in carrying out the present invention resides in the fact of having available fibers and a resin which present very close refractive indices. In the present form of embodiment, two basic resins which were mixed, were used, one of these resins having a refractive index higher than that desired, and the other having a lower refractive index.

A resin was thus used, constituted firstly, by 45% by weight of a Bisgma resin whose refractive index, measured in the visible range at 25.degree. C., is 1.550, secondly, by 45% by weight of a triethylene glycol dimethacrylate resin, whose refractive index, measured in the visible range at 20.degree. C., is 1.460 and, thirdly, by 10% of colloidal silica.

A resin was obtained, whose refractive index is 1.510. Such a resin may advantageously be used with fibers whose refractive index will be close to such a value.

Furthermore, it has been ascertained that the addition of silica had the effect, on the one hand, of giving the resin or the resin mixture, a thixotropic character, which facilitates the operation of elaborating the retention pin, particularly the operation of pultrusion or of moulding, and, on the other hand, of slightly increasing the value of the refractive index, which makes it possible to adjust the value thereof precisely with respect to the refractive index of the fibers which it is desired to use.

### EXAMPLE 4

In this form of embodiment of the invention, dental retention pins were made, conserving the same type of fibers and using a polyester resin. This resin, once associated with its diluent, had a refractive index of 1.546 (Visible range at 20.degree. C.). As before, the fibers were arranged oriented in the longitudinal direction and continuously over the whole length of a rod, and 64% by volume of fibers for 36% by volume of resin was used. This rod was then cut up so as to form dental retention pins about 20 mm long.

Tests showed a good opacity of these retention pins to X-rays and a good transparency, i.e. a good capacity to transmit, from upstream towards downstream, the light energy necessary for the polymerisation of a photopolymerisable adhesive.

As for the mechanical properties of the dental retention pins thus obtained, the following values were measured:
Breaking stress at flexion: 1476 MPa
Modulus of elasticity in longitudinal extension: 41 GPa
Modulus of elasticity in flexion: 49 GPa
Interlaminary shear stress: 68 MPa

It was thus ascertained that these values show the good mechanical quality of these retention pins.

### EXAMPLE 5

In this form of embodiment of the invention, dental retention pins were made, conserving the same type of fibers and using an epoxy resin of Bisphenol A type associated with a diluent itself constituted by a methacrylate resin whose refractive index was 1.539 (Visible range at 25.degree. C.). This resin, once associated with its diluent, had a refractive index of 1.556 (Visible range at 20.degree. C.). As in the preceding Examples, the fibers were arranged oriented in the longitudinal direction and continuously over the whole length of a rod, and 60% by volume of fibers for 40% by volume of resin was used. This rod was then cut up so as to form dental retention pins about 20 mm long.

Tests showed a good opacity of these retention pins to X-rays and a good transparency.

The measured values of their mechanical properties which were the following:
Breaking stress at flexion: 1468 MPa
Modulus of elasticity in longitudinal extension: 45 GPa
Modulus of elasticity in flexion: 49 GPa
Interlaminary shear stress: 64 MPa

show the excellent mechanical quality of these retention pins.

1. A dental retention pin made of composite material comprising:
a core of fibers embedded in a resin matrix, the resin matrix comprising at least one resin and a solvent, wherein,
the pin has two opposing ends along a longitudinal axis,
the fibers are oriented in the core in a manner that is parallel to the longitudinal axis and continuously from one end of the pin to the other,
the pin is able to transmit light from the one end to the other end,
the fibers, which have a refractive index (n), are radio-opaque,
a refractive index (n′) of the resin matrix has a value within 0.15 of that of the fibers, and
the fibers are alkali resistant (AR) fibers.

2. The dental retention pin according to claim 1, wherein a proportion of the fibers in the retention pin is less than 70% by volume.

3. The dental retention pin according to claim 1, wherein the solvent comprises a resin.

4. The dental retention pin according to claim 1, wherein the resin matrix comprises a mixture of at least two resins.

5. The dental retention pin according to claim 4, wherein at least one of the two resins has a refractive index greater than that of the fibers.

6. The dental retention pin according to claim 1, wherein the resin matrix comprises one of amorphous silica and metal oxide fillers.

7. A process for making a dental retention pin having a core of radio-opaque fibers extending from one end of the retention pin to the other and which are embedded in a resin matrix, the process comprising the steps of:
making the resin matrix from at least one resin and a solvent, so that the resin matrix has a refractive index within 0.15 of that of the fibers; and
embedding in the resin matrix a minimum quantity of the fibers for giving the retention pin mechanical characteristics and a degree of radio-opacity desired; wherein
the pin has a length and a longitudinal axis,
the fibers are oriented parallel to the longitudinal axis and continuously from one end of the retention pin to the other,
the fibers are AR fibers,
the pin is able to transmit light from the one end to the other end.

8. The process according to claim 7, wherein the refractive index of the resin matrix is adjusted by mixing resins with different refractive indices.

9. The process according to claim 7, further comprising the step of adjusting the refractive index of the resin matrix by adding amorphous silica or metal oxide fillers.

10. A composite rod comprises
a core of fibers embedded in a resin matrix, the resin matrix comprising at least one resin and a solvent,
the fibers are oriented in longitudinal direction and continuously over the whole length of the rod,
the fibers, which have a refractive index (n), are radio-opaque;
a refractive index (n′) of the resin matrix has a value within 0.15 of that of the fibers.

11. A composite rod according to claim 10, wherein the fibers are AR fibers.
